(19) United States
(12) Patent Application Publication
(10) Pub. No.: US 2010/0306773 A1
(43) Pub. Date: Dec. 2, 2010

(54) Instant on Platform

(76) Inventors: Mark M. Lee, Saratoga, CA (US); Philip Sheu, San Jose, CA (US); Robert P. Ha, Saratoga, CA (US); Thomas Deng, Cupertino, CA (US); Wenchi Fang, San Jose, CA (US); Xun Fang, Livermore, CA (US); Yuchung Lu, Cupertino, CA (US)

Correspondence Address: GLENN PATENT GROUP, 3475 EDISON WAY, SUITE L, MENLO PARK, CA, 94025, US

(21) Appl. No.: 12/513,827

(22) PCT Filed: Nov. 2, 2007
(86) PCT No.: PCT/US07/83499

§ 371 Date: Aug. 12, 2010

Related U.S. Application Data
(60) Provisional application No. 60/864,561, filed on Nov. 6, 2006.

(51) Int. Cl. G06F 9/455; G06F 21/00; G06F 1/00; G06F 12/02; G06F 11/00; G06F 17/00; G06F 17/30; G06F 9/00; G06F 15/16

(52) U.S. Cl. 718/1; 726/26; 713/324; 711/173; 726/24; 726/15; 707/640; 707/674; 707/610; 713/2; 709/217; 707/E17.005; 711/E12.002

(57) ABSTRACT

A method and apparatus allows multiple computer operating systems (OS) and/or personalities to run concurrently. An instant-on platform includes a resource management service, a caching service, a profile manager, a network stack which provides TCP/IP communication to the OS, and at least one appliance. The instant-on platform can be placed in the path of network and disk traffic between said user OS and actual system hardware. User selectable profiles and personalities are also provided.

### CROSS REFERENCE TO RELATED APPLICATIONS

This application is a national phase application of PCT/US2007/83499 filed 2 Nov. 2007, which claims priority to U.S. provisional patent application Ser. No. 60/864,561, filed 6 Nov. 2006, which application is incorporated herein in its entirety by this reference thereto.

### BACKGROUND OF THE INVENTION

1. Technical Field

The invention relates to a computer architecture. More particularly, the invention relates to an instant-on platform.

2. Description of the Prior Art

In computing, virtualization is a broad term that refers to the abstraction of computer resources. One useful definition is a technique for hiding the physical characteristics of computing resources from the way in which other systems, applications, or end users interact with those resources. This includes making a single physical resource, such as a server, an operating system, an application, or storage device, appear to function as multiple logical resources; or it can include making multiple physical resources, such as storage devices or servers, appear as a single logical resource.

In computer science, a virtual machine (VM) is a software implementation of a machine (computer) that executes programs as a real machine.

### SUMMARY OF THE INVENTION

The invention provides a method and apparatus that allows multiple computer operating systems (OS) and/or personalities to run concurrently. An instant-on platform includes a resource management service, a caching service, a profile manager, a network stack which provides TCP/IP communication to the OS, and at least one appliance. The instant-on platform can be placed in the path of network and disk traffic between said user OS and actual system hardware. User selectable profiles and personalities are also provided.

### BRIEF DESCRIPTION OF THE DRAWINGS

FIG. 1 is a schematic block diagram showing appliance selection in accordance with a preferred embodiment of the invention;

FIG. 2 is a schematic block diagram showing a plurality of user-actuated buttons for initiating various features of the invention;

FIG. 3 is a block schematic diagram showing where different pieces of the invention can reside in a PC;

FIG. 4 is a block schematic diagram showing boot process of the invention as integrated with the BIOS;

FIG. 5 is a block schematic diagram showing a system architecture according to the invention; and

FIG. 6 is a block schematic diagram showing a multi-personality profile manager at an OS level according to the invention.

### DETAILED DESCRIPTION OF THE INVENTION

The invention provides an instant-on platform. In one embodiment, the invention adds an instant-on environment to notebook and desktop PCs. In this embodiment, a consumer can use the PC within five to 10 seconds of pressing the power button. The environment contains key virtual appliances, such as a DVD player, browser, e.g. to access Internet, find map directions, find contact information, check email, etc, diagnostics, etc. The invention has no impact on existing OEM hardware design, with the possible exception of increasing the boot firmware footprint by a small amount.

The manner in which the invention is realized involves inserting a small footprint operating system and virtual appliances into the boot ROM of a system. When the power button is pressed, the boot firmware starts executing. To minimize boot time, the boot firmware only executes partially, just enough to ready the hardware for instant-on OS operation. Execution jumps to the instant-on OS to initialize hardware, launch the GUI menu, and thus display available virtual appliances to a user. In this embodiment of the invention, the OS and virtual appliances are optimized for fast boot. Thus, the GUI menu may show available virtual appliances, virtual appliances on a USB flash drive (if present), virtual appliances on a hard disk drive (if present), and virtual appliances online (if the PC is online). When the user is done, the user can either power the system off directly or exit the instant-on OS to boot, for example, the Windows operating system. Upon exit, the boot firmware continues execution and then loads the user OS normally, e.g. Windows.

The instant-on OS and virtual appliances reside in the boot ROM along with the original boot code. To implement the invention, the original boot ROM is replaced with a larger boot ROM having an identical footprint. No hardware redesign is needed to implement the invention. The OS and virtual appliances are designed for small size.

Alternative approaches to expanding functionality and the amount of space for an appliance include using an external USB flash drive for code storage, for additional virtual appliances, etc; and downloading or streaming additional virtual appliances or additional functionality, e.g. drivers, from the Internet. For example, the invention may use the http or https/P2P protocols to prevent problems with firewalls. Where the base browser is limited in functionality, e.g. due to footprint constraints, additional browser components, such as JavaScript, Ajax, foreign language fonts, etc, or a full-featured browser, can be delivered from sources online. Also, where the base browser is limited in functionality, usually due to footprint constraints, a gateway may be provided that renders all rich, online content, e.g. JavaScript, Ajax, etc, into a format optimized for the base browser's display capabilities.

The approaches described above require modifying BIOS code to jump to an instant-on OS. In other embodiments, there may be approaches to achieve a similar result without having to modify the boot BIOS. This may allow usage of the instant-on OS in today's existing systems. The invention may allow the creation of an instant-on, OS system-option ROM. The BIOS by default automatically finds and executes option ROMs as part of the normal boot process. This may result in a longer boot time than modifying the BIOS to jump to the instant-on OS directly. If most of the existing BIOS boots quickly enough, then it may be acceptable to have a BIOS complete in a normal boot sequence, and then load the instant-on OS. In this embodiment, the only change needed is configuring the BIOS settings to set the proper boot order. Some other handshaking methods that exist in today's BIOS may be used, for example, to pass control to an instant-on, real-time OS from early in the execution of the boot BIOS.

In addition to the discussion with regard to the GUI menu there are alternative approaches and other embodiments of the invention as well. For example, the first screen displayed on the computer upon starting the device would be to show choices as icons, e.g. available virtual appliances (VAs). The user can make a selection either by clicking on an icon with a mouse, or by pressing a function key associated with the icon. In other embodiments of the invention, an OEM may designate hotkeys on the keyboard for booting into instant-on operating system and/or booting directly into a particular virtual appliance. If the instant-on platform predicts a particular event that is linked to a virtual appliance, that virtual appliance can be launched automatically without the user clicking on the icon, e.g. by automatically playing a DVD if a DVD movie is inserted into the disc player on the PC.

For the existing installed base of PCs without an instant-on platform, it is possible to retrofit such devices with instant-on functionality. This may be done via a combination of a new boot-ROM image, plus software installed into local storage, such as the hard drive, USB dongle, or flash device. Alternatively, as previously mentioned, the order of boot devices may be modified, such that the boot ROM can complete normally and then hand off to the instant-on OS instead of to the user OS, e.g. Windows.

### Applicability to Other Devices

The applicability of the instant-on platform is not limited to notebook or desktop PCs, which traditionally suffer from the longest boot times. Other devices that have significant boot times and can benefit from the instant-on usage model include UMPCs, PCs, kiosks, and handhelds, such as smartphones and iPods.

Systems currently in use take 30 to 60 seconds for the regular OS to boot. However, the PCs use is typically for target or popular tasks with a five to 10 second boot. Further, the invention allows a secure, virus- and spyware-free environment. The instant-on environment runs out of a read-only boot ROM. If desired, the system can use only RAM as the workspace with no access to personal storage, e.g. the hard drive. This means that the instant-on environment is safe from online viruses, malware, etc. The user configuration that needs to be stored for user convenience, e.g. browser bookmarks and the like, could be handled in a variety of ways, including online storage, e.g. Yahoo bookmarks.

In one embodiment, a ready-to-run motherboard, without a hard drive and without loading an OS, can be provided. The motherboard can serve useful purposes even when no hard drive is available or when the user OS is not installed. With a sufficient collection of virtual appliances, a commercial-user OS may not even be needed.

The invention also allows for better power management. By having full control over the hardware and by providing an assortment of virtual appliances, the instant-on OS can have knowledge of exactly what level of hardware resources are needed. The instant-on OS can power off or throttle down components and processors to the minimum level required. This achieves power savings over a general-purpose OS. Further, hardware can be disabled or throttled down, i.e. run at lower clock rates, and includes such things as processor cores, DRAM, hard drives, optical drives, LCD backlighting, and I/O busses.

### Support

If the OS, e.g. Windows, does not boot, the instant-on platform's diagnostics and/or antivirus-appliance features could help with various diagnostics and repair actions. The invention allows the downloading of platform-specific drivers from an OEM Web site, which reduces the need for a driver/recovery CD-ROM to be shipped with every PC or motherboard. The invention allows the user to perform diagnostics that are traditionally done by OEM support tools or by use of a recovery CD. Optionally, feedback may be provided to the OEM as a result of such diagnostics to help with problem resolution. If the OEM has additional diagnostic tools or a CD-ROM, those can be downloaded and/or burned into a CD using the instant-on platform. This reduces the need for a recovery CD-ROM to be shipped with every PC or motherboard. The instant-on platform can also be used to scan the OS, e.g. Windows, and a partition for viruses and for downloading BIOS updates. For example, in the case of the Vista operating system, the instant-on platform can also inject updated drivers or application into a Windows partition to repair and/or enhance the Windows operating system.

The invention allows the OEM to establish a direct relationship with end users. OEMs can use the instant-on platform as a channel to interact with and learn more about its customers. For example, the instant-on menu can show an OEM's branding, and an instant-on browser can default to the OEM's online forum for product support, questions, and other product interests.

The invention provides an ultimate platform for innovation as well. OEMs can innovate on top of the instant-on platform by implementing their own instant-on virtual appliances that further differentiate them and their offering from those of others in the market. These innovations are not tied to the base OS, e.g. Windows.

Some virtual appliances may model, for example, a movie appliance that the user can pay for, and which can stream down movies that the user can watch, with payment shared by a movie studio, OEM, and a portal. Some premium virtual appliances may also be provided for user payment at activation, for example, a multiplayer online game.

### Embedded Environment Features

The invention collects platform-capability, user information, and unique identification information via a profile manager. A virtualized guest OS, such as Windows, does not see related hardware and capabilities. This is because the invention provides a solution that starts running before the virtualization layer is initialized. The invention can collect and help manage information, such as platform capabilities, user information, and unique IDs. For example, the invention can provide platform capability collection. In this embodiment, the invention can collect information concerning the CPU, such as the number of cores, cache amounts, power-management features, virtualization support, multi-threading support, etc. The invention can provide memory-capability information, such as cache amounts, ReadyBoost/ReadyDrive/Robson capabilities, main-memory partitioning, etc. Graphics capabilities can also be identified, such as 2D and 3D capabilities, virtualization support, processing element configurations, etc. The invention can be used to identify the chip set, including power-management capabilities, bandwidth, and, thus, allocation. The invention can also be used to identify I/O functionality, such as physical drives, NICs, expansion ports, slots, and capabilities, etc.

The invention can also be used for a platform capability management, such as resource allocation and prioritization. For example, the invention can be used to dedicate a single CPU to a given workload, allocate a certain amount of memory for a given CPU or a graphics controller core, allocate bandwidth between network devices, maintain graphs for virtual chronological, and physical device profiles, etc. Additionally, the invention can be used for power management.

In another embodiment of the invention, user information and unique identification information may be managed. For example, the invention can store user names, passwords, and other associated account information for different facilities on the local machine, external expansion devices, such as a USB flash drive, as well as for services on the network, such as Web sites, subscriptions, etc. The invention can map this information to personalities and appliances, such as this information can be shared, cached, or synchronized across the different environments, so that the user does not need to enter the same information all the time. Usage and demographics profiling information may also be collected and associated to facilitate the delivery of relevant software, advertisements, or other services.

A unique ID may be implemented and used in such a way that the user or other software can control the amount of information exposed to third parties. For example, usage information may be provided only for aggregation purposes, or only potential subsets of the profiled information may be provided to a given site, etc. The unique ID could potentially be created by leveraging hardware resource fingerprints, i.e. MAC address or a combination of other unique numbers, and may also be used for authentication purposes. In general, both the platform capability and the user information and unique ID can be used by higher-level software, including hypervisors and virtual machine monitors, operating systems, drivers, applications, or even services, for customization, profiling, or optimization purposes.

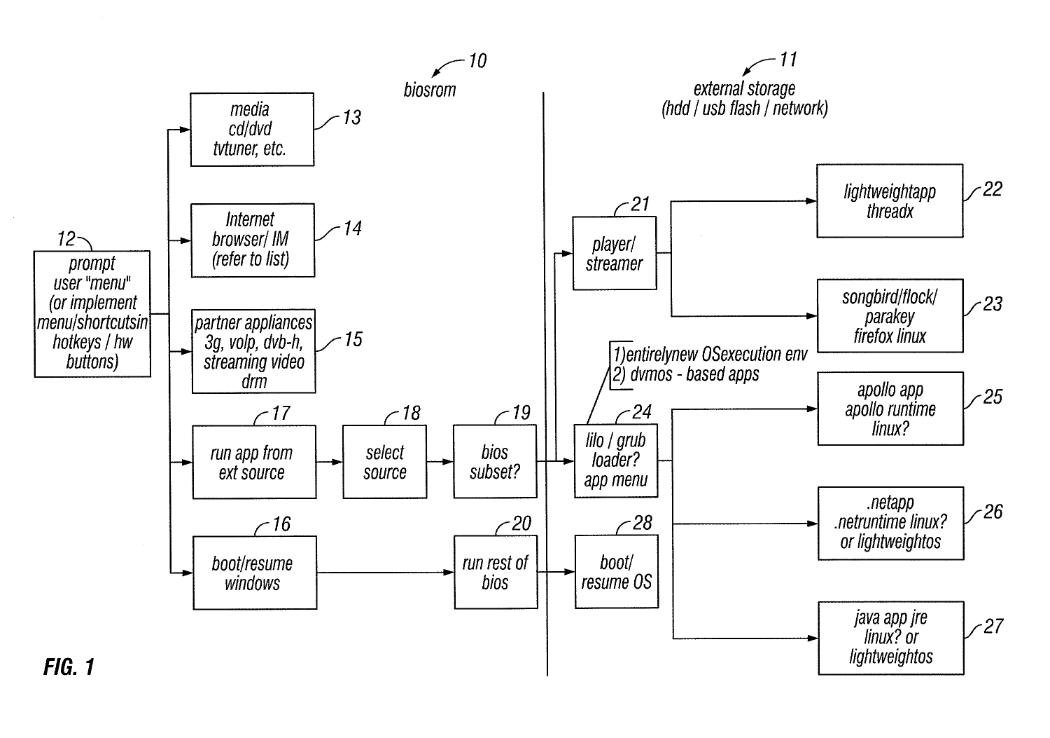

FIG. 1 is the schematic block diagram showing appliance selection in accordance with a preferred embodiment of the invention. In FIG. 1, a physical partition is shown between the BIOS ROM (10) and external storage (11), such as a hard disc drive, a USB flash drive, or network.

In the invention, a menu can be used to select appliances based on platform capability or it can go to a general OS, for booting the OS, or restoring it from hibernation. This can be done either using onscreen menus, buttons, or hotkeys. For example, in one embodiment the invention uses the VGA, mouse, and/or keyboard capabilities built into the BIOS ROM to display the menu as quickly as possible (12). This is similar to the graphics and user-interface capability of the BIOS set-up screens. In alternative environments, the invention can use facilities that exist in pre-OS boot, such as the menu screens provided boot loaders such as Grub/Lilo. The invention may display the menu after loading a portion of the operating system associated with a virtual machine and the necessary drivers. For example, it may be done after the kernel loads but before all drivers and graphics libraries are fully loaded. In an alternative embodiment, the invention may display the menu after the full virtual operating system has booted, along with graphics subsystems. This may be a preferred option if all applications are based on the virtual OS and reduces latency between appliance selection and application availability.

The latter approach may be implemented in a single level of menus or in a multilevel structure. A multilevel implementation is illustrated in FIG. 1 to provide access to a number of built-in, commonly-accessed appliances and applications but having one item point to appliances and various applications from an external source. If the user selects the external source, then the system can bring up a list of external sources for the user to choose from. Once the desired external source is selected, the appliances and applications available from that source may be displayed. The single-level, flat menu model is faster to navigate, but may be cluttered and may take a longer time to perform the correct level of accessing and cataloguing appliances and applications. The multilevel model may provide a more natural grouping and organization for the user to find the application appliance that he is looking for and would allow a faster, more responsive interface because fewer things need to happen on each level of the menu than in a flat-menu scenario. Such events requiring the flat-menu scenario would be devices covering enumeration of appliance cataloguing of all devices. A disadvantage of the multilevel approach is the use of the multiple keystrokes and screens.

In FIG. 1, from the prompt menu, (12), a user may select from media (13), a browser (14), and partner appliances (15). The user may choose to run applications from an external source (17), as discussed above, or may boot or resume the native operating system (16), e.g. Windows. If the user chooses to run an application from an external source, the source is selected (18) and a BIOS subset is invoked. A subset (19) is invoked if necessary. For example, if the external source is a media player or a streamer (21), then a lightweight application may be invoked (22) or a particular application (23) might be invoked. Alternatively, an entirely new OS environment may be invoked (24) such as an Apollo application and Linux (25) or a net app (26), or a Java application (27). In the event that the boot of the native OS, e.g. Windows, has resumed, then a boot-OS resume is implemented (28).

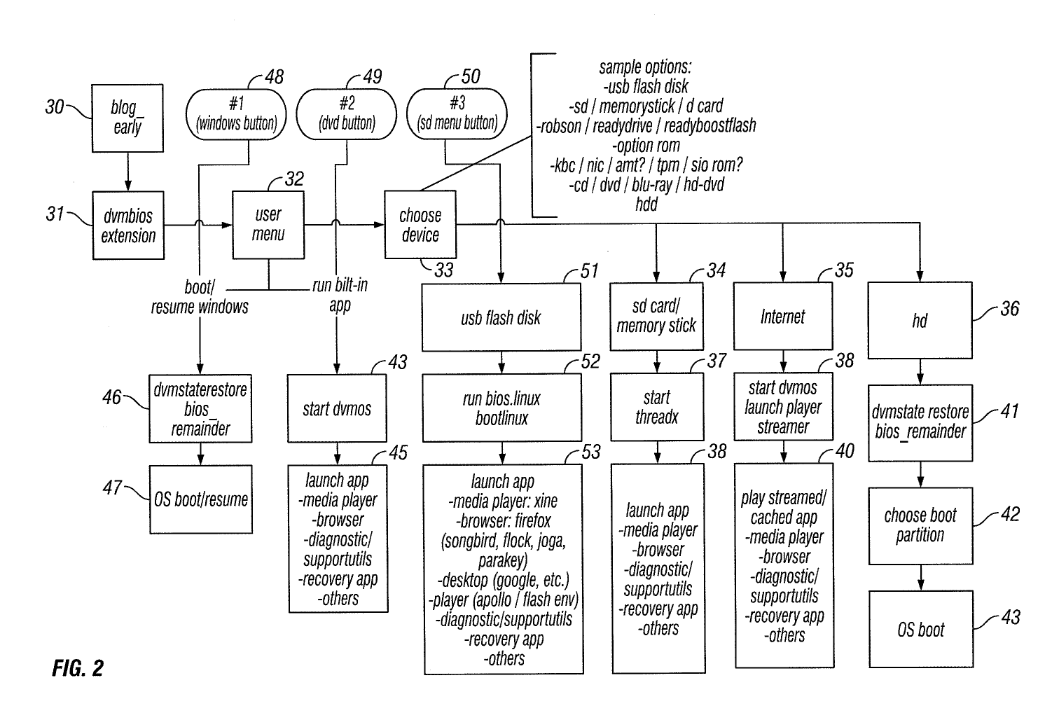

FIG. 2 shows an embodiment of the invention that provides a plurality of user-actuated buttons for initiating various features of the invention. Thus, the invention may provide keyboard and/or hardware button shortcuts to switch or activate certain appliances automatically. This may be configured hardware or a software configuration that, when the software is installed, is accessed by the user directly. These may consist of buttons on the mouse, hotkeys, and function keys directly on the keyboard, hard or soft buttons directly on the device chassis, or even remote controls on other peripherals. Facilities may also be provided to associate favorites, recently-used items, or otherwise highly-ranked items to bring them to bring them to a higher level on the menu structure. In the preferred embodiment, there is a menu always up first to show these capabilities before the general OS, e.g. Windows, has started up, regardless of whether Windows has started from a clean shutdown, a suspend, or resuming from hibernation.

In FIG. 2, the instant-on invention with the BIOS (30) brings a user menu (32) up for display to the user. From the user menu, the user selects the main operating system (48), which restores the system state (46) and boots the main operating system (47), e.g. Windows. The user may also select DVD (49), which runs a built-in DVD player application.

The instant-on invention allows for the showing of news, video, music, advertisements, or other capabilities while the main operating system, e.g. Windows, is virtualized and booted or restored from hibernation. Thus, virtualization allows for concurrency. One powerful usage of the aforementioned capabilities provides a mechanism to engage the user in meaningful activity, such as displaying information, advertisements, providing research, playing media, etc, while the user is waiting for the main operating system and application to become available. This level of concurrency might be made possible by taking advantage of the platform's virtualization capabilities or making use of any multithreading or multi-core capabilities the platform may provide. If the invention is implemented through virtualization, the virtualization engine (hypervisor/cybervisor, virtual machine monitor, or other necessary software) may be run directly from local storage, either BIOS ROM, hard drive, direct attached, external storage, such as a USB flash drive, streamed or downloaded to the computing device, are executed directly from the network.

Another use of the technology is to engage in non-interactive activities, such as pre-fetching, caching, streaming useful content or applications and appliance data while the user is waiting for the main OS and applications to become available.

Generally, the invention takes advantage of any spare system resources while the rest of the system is engaged in starting up, or resuming the main OS to provide additional value, whether it is to engage the user or to accelerate system performance in some manner.

The instant-on environment in accordance with the invention enjoys a real-time interrupt using a hotkey. In this embodiment of the invention, a quick and easy way of accessing instant-on capabilities in appliances is provided, regardless of the state of the system. As discussed above, the invention provides keyboard shortcuts and hardware buttons which provide the ability to bypass some or all of the menu facilities. The extension of this capability provides the ability to quick-switch whether the system is off, in standby, or in hibernation modes, or when the system is on. When the system is off or in hibernation, pressing the associated keyboard shortcut or hardware button may run the menu systems and start the instant-on environment directly with few complications. When the system is in standby mode, a facility is provided to store the hibernation file to disc and store any other necessary system states and parameters before starting the instant-on environment. Similarly, if the system is running when the hotkey or a button is pressed, facilities may be provided to shut the system down, put the system in standby or suspend or sleep mode, or in some other manner store enough system state information for resumption at a later time before turning off the instant-on environment.

The invention also comprises a manager of appliances and appliance data. In this embodiment of the invention, some information is either streamed down to the device or already pre-cached, for example, in a hard disc drive, USB flash drive, or otherwise. The invention creates a partition for caching and creates a workspace on an existing partition, such as direct view or a file, where the virtual appliances can be stored. As discussed previously, one implementation option is to access software and content stored locally, whether it is in some non-volatile storage component directly on the system mainboard, on some expansion board or riser, on a hard drive or an optical drive, on external flash devices, such as USB flash discs, SD memory discs, memory cards, memory sticks, or USB-attached drives.

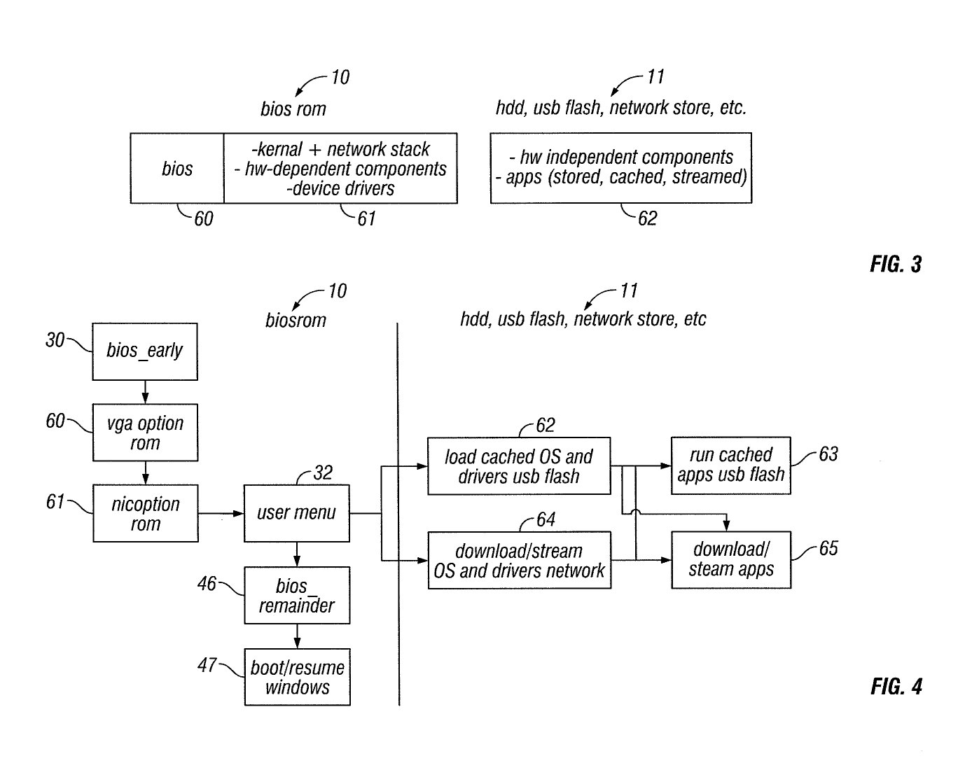

FIG. 3 is a block schematic diagram representing such environment. In FIG. 3, a BIOS ROM (10) includes a BIOS (60) and a kernel and network stack, hardware-dependent components, and device drivers (61). An external memory (11) such as a hard disc drive, USB flash drive, network store, etc includes hardware-independent components and applications which are stored, cached, or streamed (62).

In this embodiment of the invention, the software or content may be installed or downloaded previously onto these devices or, instead, may have been cached in workspaces in all of the devices. Alternatively, the software and content may be executed remotely or streamed directly from the network. Where the remote server delivers or streams an application to the system, such applications could be packaged applications that load directly into memory without an installation requirement and could optionally be cached in local storage such as a hard disc drive, USB dongle, or flash devices.

The instant-on environment has a facility for managing the data and the associated resources, including the necessary storage and/or processing capabilities record and execute and access the data. For example, the instant-on environment may provide for the seamless retrieval of appliances or content from virtual storage, either from a network, a local flash, a motherboard, a local hard disc drive, or an attached USB flash dongle, depending on the proximity and freshness of the information. In one embodiment, as shown in FIG. 3, the instant-on environment may execute out of the BIOS ROM, but many or even all of the hardware-independent components and applications may be stored, or cached, on different storage devices, or even streamed directly from the network.

In addition to applications, appliances, and content data for use directly within the instant-on environment, the instant-on environment may also access network resources and services to download platform-specific drivers, utilities, or applications, or content for use in the main system. For example, in one embodiment all content may be made available for playback and usage in the DVD environment or within the main OS, e.g. Windows.

These facilities may include the ability not only to download system software, but also system firmware, such as option ROMs and BIOS updates. The instant-on environment provides a facility to administer support, diagnosis, and/or update the system locally or remotely, whether this is the instant-on environment itself, system firmware, or system software. For example, as shown in FIG. 4, only a tiny instant-on OS and a minimal set of drivers are executed from the BIOS ROM (10). The production drivers and environment may be streamed or cached through the network. This may be one way of providing a well-validated kernel which does not impact the flash size, but allows for easy installation and use of a full, up-to-date instant-on environment from a network. The new menu (32) and network access may be implemented using the VGA (60) and NIC (61) drivers built into the BIOS option ROM.

Thus, in FIG. 4, the BIOS ROM uses such resources or makes it necessary to establish the user menu (32) from which cached OS and drivers may be loaded from the USB flash (62) and from which cached applications (63) may be run; or by which the OS and drivers may be downloaded or streamed from the network (64) and applications may therefore be downloaded or streamed to the system (65).

The instant-on environment may also provide the capability to validate or verify the authenticity of all data and packages. This may be implemented simply as a check sum or CRC, or include more elaborate schemes, such as digital signatures and central registries.

In one embodiment of the invention, a low-end browser might require a proxy server to render assistance. To optimize memory allocation and utility, the instant-on environment may provide a full browser with extensive plug-in capabilities or a minimal browser experience, which may not in fact render content locally on a local system, but rather would take advantage of a proxy server or other compute capability on the network to do some or all of the rendering. The system would then send in immediate results or a representation to the instant-on environment for display.

A further embodiment of the invention provides multi-language support and internationalization capabilities within the instant-on environment. This may be for localized user experience, as well as for support considerations. The user interface itself may be localized but, in addition, other facilities such as spell-checking, font and including libraries, user input methods, including speech and handwriting recognition and keyboard methods, and translation tools, text-to-speech and speech-to-text tools, and the like may be provided.

### Locations for Code

Depending on the hardware and peripheral configuration of the PC or device, the instant on code can reside in one or more of the following areas, depending upon available memory space, usage models, etc:

BIOS Flash (EFI): instant on code can be stored in the current BIOS from flash (512K-1M) R EFI ROM/(1-2M) if there is any available space not taken by the BIOS code of the system. Alternately, the OEM/ODM can provide a larger BIOS for the eCode with which the invention is placed.

Separate Flash Onboard: Adding an additional flash chip to the PC or PC motherboard is one solution. In this case, the BIOS would call to execute the PC code during the boot sequence. The code can also be in a PCI card. Alternately, the code can be stored as an option ROM such that when the BIOS boots, it calls this option ROM code to execute.

USB Dongle or other external memories such as SD memory cards, memory stick, compact flash, etc: The instant on code can be stored on external USB flash memory when there is not enough memory onboard the system or when portability and/or mobility is needed for the instant on code.

Robson/ReadyBoost Flash: The instant on code can be stored on additional performance enhancement flash memory card by Intel's Robson technology and Microsoft's ReadyBoost technology, for example as used by the Vista operating system.

KBC flash: The instant on code can be stored in Access keyword controller chip flash (KBC). The KBC generally has 64 kb to 128 kb of flash built in. Companies such as Renesas offer KBCs with up to 1 meg of internal flash. The 1 megabit flash card enables OEMs to put their BIOS code in the KBC.

NIC/Chipset Flash: In vPRO/AMT style motherboards, there is flash memory available for third-parties to use with the chipset or NIC. The instant on code can be stored in this available flash.

Gigabyte i-RAM Type PCI-E Card: This type of component is built with volatile memory with no power interruption, i.e. it is battery-backed. The component acts as a hard disk drive with the benefits of a flash memory. The instant on code could be stored in this type of component if available.

TPM Flash: Typical TPM have about 64 kb to 128 kb of internal flash. Following the logic of the motherboard discussed above, larger flash may be available to embed the instant on code. Due to security concerns, those implementing the invention could work with TPM hardware/firmware providers to embed the instant on code.

Hard Disk Drive: The invention would operate with a separate partition created on a hard disk drive to store the instant on code on a flash portion of a ReadyDrive for quick access and power saving.

Stream from Network: The instant on code could be stored with user interface, network setup, and many of the appliances can be stored in the BIOS, but the rest of the software components would be streamed from the network.

### Appliances

The appliances that may be used in connection with the instant-on invention described herein include, for example, the following:

A browser appliance can be provided for browsing email, news, searching, music, videos, instant messaging, social network, and the like, to support Web-based applications, appliances, and clients by providing an instant-on, fully functional browser that allows plug-ins, such as Flash, Java Script, and AJAX support. The instant-on lightweight browser is supported by a proxy server in some embodiments for rendering sophisticated Web pages. The browser appliance also enables instant access to Web 2.0 and Office 2.0 contents and services, such as RSS feeds and the like. The browser appliance may include private browsing mode for Web access that are not to be cached, stored, tracked, logged, or correlated with any other Web accesses.

A guest appliance may provide an environment where other users are allowed to access the hardware capabilities of the device, but where no persistent storage of guest user activity is provided such that guest user data is not stored. This limits or prevents access of a guest to the main system in the primary user storage. Such appliance may be useful for installations or access with regard to children, one-time guest users, and the like.

A Webtop/desktop appliance which would provide both online and offline access to a Webtop- or desktop-type interface, such as any of the online office suites or Google Desktop.

An IM appliance may be provided to support custom IM clients and use.

A DVD appliance may be provided for DVD, Blu-ray, and HD DVD applications. In this embodiment, the instant-on media player is capable of supporting DVD, Blu-ray, and/or HD DVD playback content which may be local, streamed, or downloaded.

A gadget/widget appliance may be provided which is installed in the system running a general OS, such as Windows XP, Vista, Mac OS X, or Linux, and which collects information, i.e. calendar, contact list, favorites, profiles, cookies, etc, and uploads to a remote server as intermediate storage, which is retrievable by the embedded OS. The embedded OS could also upload information to the remote server, which is retrievable or updated by the general OS gadgets and widgets. Auto-synchronization would also be supported. Further, this embodiment of the invention could provide instant-on access to gadgets native to other environments, such as Apple, MySpace, Vista, or Google.

A slideshow appliance may be provided, for example, for a Vista gadget to provide contact and calendar information. Similar to the PortalPlayers Preface product but which implements an additional display, CPU, memory, and other components which will offer a O-BOM slideshow appliance leveraging the main CPU, memory, and display, but running in the instant-on code.

Such appliance has the following features: It is not an immediate information retrieval device. It would offer a variety of gadgets that are running on the main OS or on a partition, such as Vista, such that it can leverage slideshow technology and APIs, and such that user information may be written to files or to an appliance storage area. The appliance storage area could include a separate partition on a hard disk or on the network or in the main system hard disk partition. The appliance would retrieve information and files from the main memory and hard disk. Because this embodiment of the invention leverages the main CPU, memory, and display, users are offered a better user experience similar to the normal users' experience with the benefit of instant availability.

A hardware-dependent appliance may be provided, either integrated into the motherboard or attached to a USB memory. The instant-on code to support the head end hardware-dependent appliances and applications, such as meeting communication appliances, includes such application as DVB-H/mobile TV appliances, which is not an appliance integrated with the DVB-H (Digital Video Broadcasting Space—Handheld), and any other hardware to support multimedia contents from the DVB-H network. A cable TV tuner appliance integrated into the instant-on appliance, for example as a TV tuner card, to support multimedia contents from service providers. 3G appliance (BREW, Access/Palm, Openwave, NTT, Korea, China Mobile . . . ) which is an instant-on appliance integrated with 3G chips (or 3.5G and beyond) to support connection in value-add services provided by carriers, such as telecom companies, mobile platform providers, and the like. A time shifting (DVR) and place shifting (Slingbox-type) appliance with peer-to-peer support. In this embodiment, through the touch of one key, which may be a hardware or a software key or selection of a menu item, a user is offered an instant on-DVR or Slingbox-type function. The necessary system resources are allocated to run this function, such that it is not impacted by the general OS running other unrelated tasks or processes that might impact performance and/or user experience. A GPS appliance that, through the touch of one key, can offer instant GPS or a platform that has such capabilities. In such application, startup and reaction time are crucial, as well as stability. The GPS appliance can be applied to all sorts of devices, such as PCs, UMPCs, in-car PCs, kiosks, and handhelds, such as smartphones or the iPod. A UWB appliance that can stream software, data, or content other devices using UWB. One application of this embodiment is the home server which can simultaneously stream video, music, and other services and files to thin clients and display it in different rooms.

The invention may comprise a VoIP appliance, such as Skype or Vonage. Use of that appliance would be provided by the service provider, ISV partner, or other to support voice over Internet protocol function services.

“Last mile” appliances may be provided, such as ISP, cable, 3G, metro WiFi, or WiMAX applications. In this embodiment, the partner would provide last mile service providers, such as Comcast or Verizon, with such embodiments the invention would allow the service providers to offer instant-on services and immersive user experiences on the inventive platform. This helps build platform and offer content and services on the PC by creating a competitive advantage that is not restricted by other stack providers, such as Microsoft. In such embodiment, 3G providers such as Cingular or Verizon can work with the provider of the instant-on service to provide an instant browse experience or gateway for the subscribers. Such system can use the provider's DRM and other solutions as necessary. In this case revenue would be shared among the service provider and the provider of the instant-on platform.

A video cam conferencing appliance could be provided in the instant-on appliance invention, where the instant-on aspect is provided by the peripheral vendor, service provider, ISV partner, or another company. The instant-on appliance is integrated into the video camera to provide video conferencing functions and services.

A media appliance provides the functionality to synchronize media and/or PIM data between the system and other portable devices, such as cell phones, cameras, camcorders, music players, etc, without starting up the full operating system. The content for the synchronization may come from the main system. Such embodiment may provide the functionality to play streaming media between the system and other devices, such as cell phones, cameras, camcorders, music players, televisions, DVD players, DVRs, etc, without starting up the full OS. The content for the synchronization may come from the main system or from another source.

A game appliance may be provided, such as a game like Nintendo, or an appliance can be provided in which game vendors create a virtual game console on the instant-on platform with the advantages that include the control over the level of system resources dedicated to the gamer's experience in contrast with running on a Windows system. For example, the game vendors can expand the number of members of their user base and the platforms that can play their games. In this embodiment, for some vendors, the game console and hardware may be subsidized. Online gamers now have simpler access to the online environment through the instant-on system which does not require the other operating system components or antivirus software and the like running. In this embodiment also, parts of the game may be cached.

A thin-client appliance (ICA, RDP, etc.) may be provided with an instant-on client site interface with a client/server-type network architecture with backend support. Such embodiment enables the standard PC platform to be used as a thin client in a client/server environment, i.e. Citrix independent computing architecture and remote desktop protocol. For example, the system administrator can limit user access to the corporate network by disabling certain functionalities, or even the main operating system, such that the PC is used only as a thin client in the enterprise. The invention would enable the instant-on menu of available functions within the network. This would provide better security for the network. Further, such system would have lower costs because a single platform could serve two purposes, i.e. local computing and network client. This would also allow the use of commodity hardware in such applications.

A music appliance, such as an iTunes-type appliance, could be provided to create an instant-on, for example, one-key touch, music player. The music may be stored in any of the storage locations, including the main hard disk partition, separate hard disk partition, external storage, such as USB and other drives, or streamed over the Internet, or even from a peer-to-peer location. This environment offers power savings because it is not necessary to run any of the other unnecessary OS processes or tasks or even turn on those hardware components such as graphics components and display components.

A play-only appliance may be provided for DRM which includes user interface or client software provided by a content provider, service provider, or other service that has a play-only function to support multimedia contents which are subjected to DRM.

A DVD/HD movie peer-to-peer appliance may be provided, such as a MovieBeam-type appliance. Such appliance can be streamed or cached, or may be provided on a USB dongle or obtained through peer-to-peer network applications. A provider of the instant-on appliance can partner with the content or service provider, such as MovieBeam. The invention allows partners to build their own appliance or UI and thereby achieve downloading or streaming of content. Alternately, the content may be pre-cached and then erased after it is viewed by the user. In such environment, the content or service provider would user their own DRM and could use the invention to offer value-add services directly on the appliance. In such case, revenue would be shared among the various partners. Further, there is a potential power savings due to the single-purpose use of the platform.

An Adobe Apollo appliance may be provided which comprises a platform using Apollo (with Flash, AJAX, HTML capabilities, etc.) that works with third-party ISV, content, or service providers to provide end user experience, rich media, and an immersive experience. This serves as a platform to generate revenue via software, content, and services for distribution or advertising. This aspect of the invention may be provided in various embodiments with other types of runtime environments, such as Java Shockwave, Flash, or even the .net CRR.

An IPTV appliance may be provided that is similar in concept to the music and movie appliance discussed above and that can work with service providers directly, with a revenue sharing option.

An online/offline appliance may be provided, for example, for pre-caching or that may be used in a social network. This aspect of the invention provides a platform to such services as Google, MySpace, Yahoo!, and others (for example using Web 2.0 or Office 2.0) such that such services can offer an appliance or agent that interacts with users no matter if they are online or offline. In a sense, this embodiment of the invention allows a service to provide a mini-server that allows the users of the service to continue to use such services, such as searching Google or using a spreadsheet, even when the users are offline. The user input information gets cached in synch with the server when the user is back online. Thus, the service providers can continue to offer services or run ads when the users are offline. In a social networking setting, this appliance allows users to upload photos or to blog and to generate content even when they are offline. Such changes to the system are synched when the users go online or the users mail others to directly access their computers. Thus, different levels of sharing are provided.

A local online/offline advertisement appliance can be provided that displays advertisements online and offline, even if the user is not online or at any Web site. The invention can cache high-quality ads and content to be served to the user when the user is offline. The invention can also take advantage of system boot times to display ads during system booting. In such an environment, the system would first configure graphics aspects of the platform and then immediately post a screen prior to the boot system. The invention can also post ads when the main operating system is booting. If an operating system is under, such as a Microsoft, an OEM license that requires a Windows boot screen to be displayed, then the invention can virtualize the screen in a separate window or in the background.

A support diagnostic appliance can be provided. In this embodiment, if the main operating system has a problem, such as virus, drivers, configuration problems, etc, the instant-on code can get access to the Internet and communicate with support teams or a support Web site. The instant-on system can use the platform to run diagnostic programs to root cause the issue. Alternatively, the instant-on platform can inject OS drivers or other software into the main OS or otherwise as needed. Further, the support team can stream over a recovery CD or software that is more updated, or they can do virus scans on the main OS itself from an isolated, lower-level environment.

A backup appliance may be provided in which the instant-on appliance creates backups of selected files and applications on a local hard disk drive or a server on the network. By leveraging virtualization, the OS environment can be treated as a file, and the different differential of the file as it is before use and afterwards can be saved, and the original image may be maintained online or as a recovery CD.

A security appliance may be provided in which the instant-on appliance performs a security check on memory devices and provides a solution of any security threats. This embodiment of the invention operates underneath or isolated from the main OS environment which is generally the target of such viruses.

A photo appliance may be provided that would allow users' friends to push photos through the appliance as with the Chumby application. This is an appliance that allows people to save and share, that is, send and receive, photos through the Internet, for example, with Web 2.0. Also, for example, a user can push pictures from the instant-on appliance to their friends' instant-on appliances or accounts, with proper security being taken. Thus, when a user boots the machine, they immediately see the new pictures, using an instant-on photo application and, for example, provided in the background. The provider of the instant-on application can partner with photo printing shops, photo sharing Web sites, etc, to offer integrated services.

A social network appliance may be provided, such as a Flock browser-type appliance. In this instant-on appliance, the client interface allows people to share multimedia contents to connect with other people through the Internet. This embodiment would link or integrate enough content and/or services, or provide software as a service, to create an immersive experience for users such that they would not have to leave this environment to get things done.

A my own Web server appliance may be provided which, if always on, is connected to a fat upstream pipe. The instant-on appliance would supply contents for personal Web page or other content with an open format. Contents could be stored on an online server and/or in local memory. The owner of the Web page could choose to make content public or open it to a certain group of people online. This allows for friends or other traffic to access the appliance and contents directly and locally with no limit on uploading size or format or form of applications.

An edutainment or elearning appliance could be provided in which the instant-on interface is supported by a backend server with education and entertainment contents and servers, such as multimedia and games. A remote home appliance could be provided which allows for using the PC as a remote access point with all of its peripherals, camera, analog/digital converters, etc, such that a user can monitor home activities, turn on or off home electronics, etc, without the instability or interruption of the OS services or even without the use of a hard drive.

A medical appliance could be provided in which the instant-on application is used for monitoring, collecting, storing, and analyzing medical data, e.g. blood pressure, blood sugar, cholesterol, etc. Such application can also be used as a remote sensoring device from remote diagnostics.

A solutions-based-home UWB NAS appliance may be provided with various appliances for accessing multiple PCs. In this case, the invention would comprise an instant-on home database for access to multiple home devices and would enable high-quality content to be served, streamed, or shared via UWB.

### VPro-like Partition

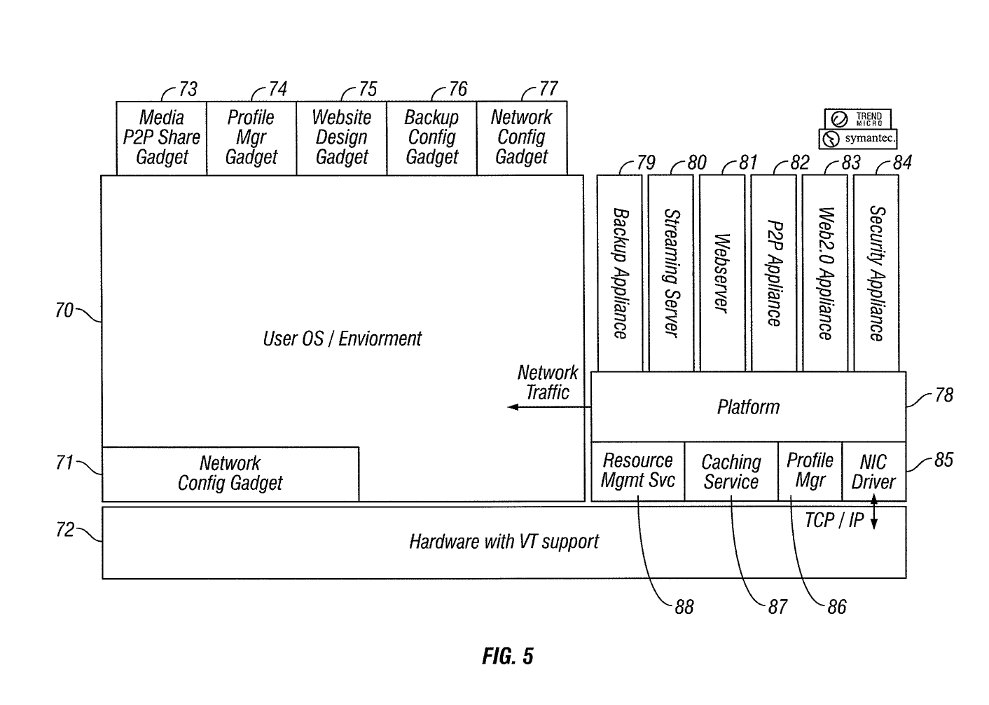

This embodiment of the invention allows multiple operating systems to run concurrently on hypervisor. This aspect of the invention uses a model similar to that of Intel's VPro, which is a lightweight hypervisor that only virtualizes the NIC. All other mean I/O, that is, disk, graphics, and audio, are not virtualized but are still controlled by the user OS, e.g. Windows. FIG. 5 is a block schematic diagram showing a system architecture according to this aspect of the invention.

FIG. 5 shows a hardware platform (72), which has a user operating system environment (70). In FIG. 5, the user OS receives network traffic from the instant-on platform (78) which includes a resource management service (88), a caching service (87), a profile manager (86), and an NIC driver (85), which provides TCP/IP information to the system (72). The instant-on platform includes such appliances, see above, as a backup appliance (79), a streaming server (80), a Web server (81), a peer-to-peer appliance (82), a Web 2.0 appliance (83), and a security appliance (84). The operating system includes a network configuration gadget (71), a media and peer-to-peer sharing gadget (73), a profile manager gadget (74), a Web site design gadget (75), a backup configuration gadget (76), and a network configuration gadget (77), the latter network configuration gadget being provided for network connections. The architecture shown in FIG. 5 is the basic architecture of the instant-on platform, including various application and appliances. This architecture can be expanded to virtualize both network and disk controllers. By placing the instant-on invention in the path of the network and disk traffic between user OS and the actual hardware, the virtual appliance can serve a variety of functions. For example, the virtual appliance can provide a VPro appliance that does backup and mirroring. The appliance operating system interfaces with the physical disk driver. The user operating system uses a virtual disk driver. Whenever the operating system writes to the disk, the appliance operating system can convert that information to backup, memory, RAID operation. This makes backup and memory transparent to the user OS. The appliance OS also offloads the user OS from the software RAID calculations.

A VPro appliance may be provided that expands user storage to online. This is similar to the discussion above with connection to backup and mirroring, except that appliance OS virtualizes both the disk and network interfaces. Whatever the user OS writes to the disk, the appliance OS can send that information over the Net to some virtual hard drive. This enables such companies as Google to provide huge or unlimited or easily expandable online storage for free or for a fee. If online storage is not fast or secure enough for all hard drive data, then the appliance OS can discern what information is being written and decide whether to send that information to a local drive or to an online drive. For example, the OS and applications would be stored locally, while huge multimedia files may be stored online.

The invention also provides the VPro appliance as a media/file server. In this embodiment, an appliance partition acts as a shared repository for music, videos, and files. The user OS and the other PCs in the user's home can connect to the appliance OS to access and add media and/or share files. This allows multiple PCs centralized storage. This is essentially a software implementation of NAS, but it is free and easy to set up.

Virtual clients may be provided for VPro uses model with no UI to make online tools available offline. For example, this embodiment of the invention may be used with MySpace, Google, or other Web-based information services such as web space office suites. This embodiment of the invention is transparent to the user of the Web sites and tools whether the PC is online or offline. For example, a Google Web-based office suite can be run as a VM appliance behind the scenes on the same PC. When the PC is online, the user accesses Google from his Windows browser. This access goes directly to the Google site. When offline, the user can still access the same Google tools, but now the access is handled locally by the Google offline suite Web server's virtual machine. In essence, Google can deliver a Google Web-based suite offline to the end user, and the user can take advantage of all the features even when not connected. Once the connection is reestablished, the Google office suite service via virtual machine synchronizes with Google online suite, updating it and uploading locally modified documents, etc. The documents can be saved to a local Windows system if desired. Another example of this embodiment of the invention includes a subset of the MySpace functionality that can be replicated as a virtual machine appliance. Even when the user is offline, the user can update the profile. The user can show other than the profile and friends' pages while offline. When connected online, the virtual machine synchronizes with the online MySpace. This enables the ability to deliver online experiences when offline.

Other VPro appliances include such applications as security, profiling and indexing, media players (DVDs, CDs, music, videos), the equivalence of the Vista slideshow, which works with Vista gadgets just like calendar, contacts, etc. These appliance are shown in FIG. 5.

### Profile Manager

Services such as YouTube, MySpace, and Flickr use Web 2.0. As the amount of information in these servers expands, all users become providers of information and data. Most Web 2.0 portals are not personal enough. For example, the top 10 favorites may appeal to some, but probably not to most others. Most sites are very U.S.-centric in their groupings and directories, etc. However, relevance is more important than ever. People increasingly lose patience with irrelevant material. Thus, users are looking for others with common interests and/or identity. The profile manager software is provided on every PC or for every user or account and allows you to input and save your personal profile. When a user searches the Internet, he can allow any portion of the profile to be sent to the Web site or portal to which he searched. Based on this profile, the Web site or portal may produce improved relevant results in content rated by people of similar profiles. For example, when a user with a profile manager visits YouTube, he'll see the most viewed or top-rated or most discussed categorized information based on people with similar profiles in addition to generic groupings.

High level of requirements of this embodiment of the invention include the fact that users only input their profiles that they desire. Users may grant the profile manager rights to collect their online and/or offline activities, history, similar to a Web clipping service in Google or Apple. When collecting the profile, users can be run through a series of questions, images, or selections to determine the profile and/or interest of the user. Users must approve the passing of profile information to each site, or they may grant access for a limited period of time or for all times. A security mechanism is provided in which information passed to the portals may be encoded and used only via pattern matching. In this way, the profile is kept confidential and cannot be spread. The profile is portable. Thus, users can carry the profile on a USB dongle or cell phone flash. The profile may also be available for online access. For those users that prefer, a Web site may be provided at which the user can park their personality for access anywhere. The invention includes a mechanism by which the profile is returned to the user after the user logs off to ensure privacy and security. If the system codes the profile, then this may not be necessary. The profile can be integrated also with browsers or a tool bar or a side bar, such as Google desktop. If selected by the user, the profile manager remembers the user actions of the past period of time to allow the user to perform relevant searches automatically. The profile manager also uses a combination of key words and coded profiles for relevant searches. For example, recent search words may be key words, but more personal data is not coded in the profile.

In the preferred embodiment, the profile and history stays with the user and not on a particular Web site or server. Therefore, users no longer have to re-enter their profile for every portal. Even for new Web sites, e.g. first time visits, users can get the benefit of personalized search and relevant content. Users can change and erase their profiles at any time for any and all portals. The user profile is kept confidential and is not kept by the portals. This aspect of the invention provides ease of use for even casual PC users. In some embodiments, the profile can be pre-bundled on a white box, laptop, or notebook, or driver installation CD. The invention enables Web sites and portals to provide their services without having to create different content and/or sites for different interest groups or even different geographies. Thus, it's much easier for content management and availability. This also allows globalization of Web sites and portals. This also enhances targeted advertising.

In one embodiment, when a user buys a PC, a wizard is provided asking the person to define their profile by answering a list of questions and indicating their preferences. The profiles are encrypted and saved. The user is asked for permission to store the information in the database online for future access. The information is synchronized periodically. When a user visits a Web site, the user is prompted to obtain user permission before the profile information is sent to the Web site. If the user agrees, then an encrypted file such as an XML file is passed to the Web site or portal. This information can be saved as a cookie so that in the future the user does not need to be asked again. The user will see the content in the search results, relevance rated by users with similar profiles. The invention creates a fingerprint or pattern of the user profile so that the user's profile information is not disclosed. The Web appliance can then use the fingerprint or pattern to deliver information to the user by matching the fingerprint. Personalized content and services can be provided without knowing the detailed profiles of the users in this way.

### P2P Social Networking

In a peer-to-peer social networking application of the invention, each person serves a profile page directly from their PC via the peer-to-peer file-sharing technologies. Thus, users can browse each others' profiles via peer-to-peer technologies. By using peer-to-peer technology, it is possible to maintain a downloading and browsing experience. This embodiment of the invention permits freedom of self-expression in which the user can use all the tools in a medium that is necessary to make publicly available instead of being limited to HTML pages or whatever structure the portal limits the user to, such as file formats, maximum size, etc. Portals such as MySpace have an advantage because they're established. However, the invention allows further exploitation of Web 2.0.

### Power Saving

The invention provides means for proving power savings via virtualization. This aspect of the invention can apply to current hypervisors, such as XEN. The invention allows the system to power down or throttle back hardware reserves to what is minimally required by currently running virtual machines. This includes powering down unused cores or scheduling. The virtual machines share cores when a computing task is not demanding. Based on the virtual machine or virtual environment running, the invention can power off certain pieces of hardware, such as the DVD/CD-ROM when an Internet machine is being used. Depending on the machine running, peer-evaluated performance requirements can be established for which a system is throttled back and/or in which processors are turned off or cores are turned off to meet the performance requirements of the currently running virtual machine.

### Pre-Installation of Personalities

The invention allows pre-installation of personalities which can comprise applications, content, services, and/or virtual machine images. Virtual machine images comprise the combination of the operating system plus applications, plus content, plus services, plus data. These personalities can be loaded into hard drives prior to the hard drive being assembled into PCs. This enables additional OSes, such as Windows, to be installed, and are added to the hard drive without impacting the existing personalities. The personalities can reside in hidden partitions and can be activated based on user profiles.

### Establishment of Systems at ODM's Factory

The invention also allows the establishment of assistance at ODM's factory and assembly lines to support provision of images, e.g. personalities to the devices. Optionally, this allows content and service providers to bid and/or auction to be integrated into these images and/or personalities.

The invention also makes complete virtual machine images and/or personalities portable via portable Flash devices. Portable Flash devices include USB dongles, cell phones, MP3 players, etc. Modern Flash devices are mainly used to transport data, content, and possibly applications. The invention extends this to transport complete virtual machine images, such as operating systems, applications, content, and/or services and personalities.

The invention incorporates a hypervisor and platform-specific drivers into the boot ROM. Any operating system installation is automatically virtualized, thus gaining all the advantages of virtualization. Thus, the systems are portable, easy to backup and restore, etc. Virtual machines, i.e. with operating systems, applications, etc., can be made available on this platform merely by drag and drop.

The invention also provides an architecture hard drive partitioning to enable separation of the operating system, application, and data. In this embodiment, the operating system is secured and locked while remotely updated in a secure fashion. The applications run inside their own containers, e.g., they're not necessary to be installed into the OS. Thus, no modification to the OS partition is needed. The application can be remotely updated as well. Optionally, the application partition can be an application server that streams containerized applications to the operating system partition. Data partition is separate and can be backed up easily.

### Personalities

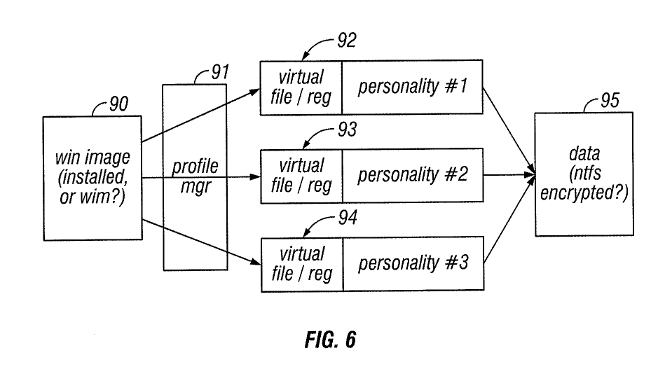

The invention also provides multi-personality windows, for example, for the Vista operating system. FIG. 6 is a block schematic diagram showing this aspect of the invention. In this embodiment of the invention, layer operation or application virtualization is provided on top of Vista, or technology is already present and Vista may be used. This provides completely separate environments within Vista for different profiles and users. Files and applications within each environment, i.e. personality, are completely separate from those of another environment and are not visible across environments. In FIG. 6, for example, a Windows image is shown installed (90), and it's controlled by a profile manager 91 which allows users to select between virtual machines (92)-(94), each of which express a different personality. Data is then stored with a separate module (95).

The invention also aggregates I/O bandwidth. Virtualization enables the aggregating of the I/O bandwidth when multiple devices are available, making that bandwidth available to guest OSes transparently. For example, when there are both DSL and 3G network access available, the hypervisor can aggregate the bandwidth. Guest OSes can take advantage of this higher bandwidth without having to be aware of the hardware involved. The hypervisor abstracts the I/O devices into a standard virtual Ethernet controller.

The invention also provides for application of virtualization. For example, child versions of applications for Vista may be offered but are packaged using application virtualization technology so that they're easy to install and delete without contaminating the user's OS environment. User application virtualization technology thus builds a sandbox within a user environment, where applications can be tried in a manner similar to USB dongle-based concepts, such as MojoPac, Ceedo, etc. If a user decides to keep an application, the application can be dragged from the sandbox to a production partition. Using just a WIM technology enables a new app model within Vista. Instead of installing applications via traditional setup programs, the applications can be pulled directly from WIM.

One embodiment of the invention provides content, services, and software separated out into containers referred to herein as personalities. These personalities provide a better user experience by enhancing the following characteristics of today's general purpose compute devices:
1) relevance
2) isolation and stability
3) performance
4) portability

### Relevance

A personality enhances relevance by offering end users pre-bundled, pre-configured, and/or pre-organized content, services, and software. Personalities can be one application on its own, e.g. a World of Warcraft personality, or a combination of content, services, or software, e.g. a Disney personality. Personalities also include packages of personalities, or super-personalities.

Personalities and super-personalities can be selected or configured at time of hardware purchase or as an upgrade or refresh after purchase. The purchaser may be given a choice of pre-packaged personalities or super-personalities, may be offered a drill-down selection, or may have personalities and/or super-personalities recommended by profile. These profiles may generated through online surveys, or import of profile data through other accounts, e.g. Netflix, Google, A9, Amazon, Yahoo, MSN, mySpace, del.icio.us, RSS, and blog subscriptions, and may consist of demographic data, e.g. age, gender, profession, and ethnic background, or of specific interests, e.g. first-person shooter games, Disney, shopping, cooking, etc.

Usability is also enhanced because the number of icons, links, and shortcuts for each personality can be reduced, and the layout of these items can be organized and optimized for each personality's particular use case.

### Isolation and Stability

Personalities provide better isolation by running in software containers which are abstracted from the underlying platform. These containers have the effect of reducing cross-contamination of viruses and spam, and conflicts between DLL's and other libraries among the various applications, drivers, and OS versions. Installation and uninstallation of personalities are made much cleaner, e.g. reduced to file copy and delete operations.

These personalities and containers also facilitate the checkpointing and recovery of system state. Due to the nature of the personalities, automated transparent checkpointing can happen much easier, merely taking a snapshot of a file, and require little or no user intervention.

### Performance

Performance is enhanced in that only those processes and services which are needed for active personalities are run at any particular time. Resource utilization can then be managed at a more reasonable level than what is available currently. Suspend and resume-type operations can also be used to save entire workspaces, personality state, thus freeing up resources for other activities.

### Portability

The consumer's experience of using personalities can be further enhanced by making the same experience available wherever the consumer has access to a PC. Providing personalities in containers with virtualization technologies facilitates putting containers onto mobile devices, such as USB drives, and then opening up the containers on any PC that has a USB port and the appropriate virtualization support.

### Personality Configuration, Installation, Update, Creation, and Maintenance

### Configuration

Configuration mechanisms and installation sources include:
OEM website and installation server on PC assembly line
CD and DVD distributed with white box
Online through website and/or marketplace
Pre-loaded on hard drive, applicable for either white box or OEM

Some personalities may have additional hardware requirements, e.g. CPU speed, amount of RAM, peripherals, etc., for optimal operation. Where this is the case, hardware recommendations can be made at the time of customer selection of personalities or hardware. Some profiles also have associated hardware recommendations, e.g. a teenager profile recommends a graphics card for gaming purpose.

One embodiment of the invention ties configuration to an installation and provisioning mechanism.

A customer's selection of personalities is the front end of the configuration process. The resulting data are passed to the back end and customer's PC is loaded with his choice of personalities. Tools are provided to facilitate the transfer of data and the loading of personalities. There are also tools to integrate this process seamlessly into OEM's or channel partner's PC assembly process.

The recommended customization for a certain profile may be as simple as a configuration, e.g. a set of favorites in a browser, one personality, e.g. a set of applications, or a group of personalities. Customer profiles can be based on demographics, interests, or data from other online companies and communities, such as:
Demographics: age, gender, ethnic background, profession, e.g. student, housewife, etc.
Interest-based: user-specified or tied to other interest-based
Tie to Netflix, Google, A9, Amazon, Yahoo, MSN, mySpace, del.icio.us, RSS and/or blog subscriptions
Groups of personalities or single personalities
Provide shopping personality based on a user profile, data, or behavior. If a customer chooses a personality bundle that includes a shopping personality, the shopping personality can be further customized based on profile to further add value to the customer, e.g. link to Pottery Barn or Crate & Barrel instead of Home Depot and Lowe's.

Another embodiment of the invention may comprise a personality of personalities, e.g. a virtual appliance concept. This embodiment creates a package of personalities that is suitable for a certain profile, e.g. family package that includes teenager and home office personalities, or performs a group of related functions, e.g. multimedia appliance package that does music, video, etc. Packaging personalities in this way simplifies the consumer's ordering process by providing pre-thought out choices.

A white box configuration workbench may be provided that allows selection of personalities and provisioning of the virtualization platform and the selected personalities. It can be distributed in the form of a DVD along with all available personalities and then run by either end user or VAR. It can also be preloaded on the hard drive along with the possible personalities.

The invention also comprises a migration toolkit, that can:
Automatically convert current legacy PC image into a personality, e.g. strip out hardware dependences or remodel
Automatically convert current legacy PC image into a personality, e.g. strip out OS dependences. This is similar to above, except it adds the ability to migrate the user's environment, e.g. applications and data, from one OS to another.
1-click migration, e.g. upload a personality from an old PC through a cloud or configurator to a new PC. This embodiment makes the migration process even easier for consumers by moving the converted PC image automatically, without requiring consumer to copy from an old PC to a new PC manually and install on a new PC. A tool on the old PC can upload the converted PC image onto the inventive system's network infrastructure, then another tool on new PC can download the image and install as a personality.

Another embodiment of the invention concerns the transfer of old versions of the Windows OS. Many consumers have old versions of Windows, whether a purchased copy or a copy that came with an old PC. These old versions may be used as guest OS for a Windows-based personality that does not require latest version of Windows. They may also enable consumer to get latest version of Windows by paying just the upgrade fee rather than the full price. A marketplace can be created to facilitate exchange of these licenses.

### Installation and Provisioning

This embodiment comprises a copy-based OEM provisioner or installer that ties in with the configurator.

The provisioning and installation tool is used by an OEM or VAR to set up a PC with the desired personalities. The installation process can just be file copies because each personality is a file, rather than a typical installation process that touches many parts of underlying software, e.g. registry, DLLs, etc. This makes the process simpler and faster.

An auto-generated recovery CD, DVD, hard-disk, or USB image shipped with purchased device may be provided. Disk images customized with consumer's choice of personalities are pre-loaded onto purchased device or as a separate disc media shipped with purchased device.

An activation-based provisioner may be provided in which all images are the same, personalities not selected are disabled or deactivated. Instead of creating customized images, a purchased device or disc media can be loaded with all possible personalities. The customer then chooses or activates desired personalities upon boot up.

Tools for user preferences, configurations, skins, and favorites, e.g. pre-configured and personalized based on profiles, are provided. Personalities for different profiles may have exact same set of applications but just different settings, e.g. favorites, skins, user preferences, and configurations. One example is a browser personality that has pre-configured links to different websites for a teenager vs. a browser with links that match a college student profile. Tools can facilitate creation of settings files and deployment of different settings to personalities.

A further aspect of the invention concerns a tie in with rebates and service contracts. The personalities that provide significant financial return to the content partner or ISV may include a rebate on purchase price of the device to the consumer. This rebate can be reflected directly in customer's purchase price. One example is a consumer that signs up for a movie personality with Netflix subscription and gets a discount on the laptop computer.

### Update and Maintenance

Embodiments of the invention comprise:
Auto update of content, e.g. refresh of top 100 lists, etc: Media-related personalities may contain content that can benefit from regular updates. For example, a karaoke personality may download every week new songs and MTVs. A movie personality may download new movies that match consumer's interests from Netflix.
Auto update of personality, e.g. patches, etc: Personalities may have feature improvements or bug fixes after their general release. The service VM can automatically update the existing personalities on consumer's PC, while keeping all consumer data and settings intact.
P2P, e.g. BitTorrent, for content and personality updates: For downloading large content and patches to customers' PCs, leverage P2P, such as Bit-torrent, to improve download speed and reduce server infrastructure requirement. Content and updates can come piecemeal from other customers. The updater can reside in a separate VM so not to affect the personalities.
P2P, e.g. Bit-torrent for new and replacement personalities: Uses the same idea as above, but for downloading new or replacement personalities. There may be a different front end to differentiate between maintenance (above item) and new feature (this item).
At set-up, allow additional personalities to be recommended or proposed and downloaded for additional rebates or subsidies (revenue shares). For example, provide a 1-click checkpoint.
A PC is preloaded with a certain choice of personalities, either by an OEM or by VAR. When a consumer boots up the PC for first time, additional personalities may be recommended for the consumer to download or purchase, to get additional rebates and subsidies (with sharing of the revenue among parties in the distribution chain).
Consumers can opt for 1-click checkpoint at that time or later during usage. 1-click checkpoint takes a snapshot of some or all personalities, so consumers can easily return to the saved state easily if some personalities get corrupted at a later point.
Remote maintenance and recovery of personalities, automated and supervised, also includes the capability to update full problem personality to site for support and repair, e.g. other users, third party service providers, etc. Personalities can be kept up-to-date by service VM regularly checking for updates and patches. Personalities can also be backed up onto a portal's servers, along with user's customizations, to help user recover if local copy of the personality is corrupted or lost. When an important personality with many user customizations is corrupted, it can be sent to a user community for potential service providers to repair.

### Personality Development Kit

The personality development kit enables content partners and ISVs to develop personalities on their own, to offer to consumers either as a pre-loaded option or as a downloadable option from the user community. This aspect of the invention comprises:
Common resource libraries and APIs for helping content partners and ISVs with developing personalities themselves:
   Driver and peripheral integration kit: Some personalities may be bundled with a peripheral, e.g. Bluetooth headset bundled with VoIP personality. The driver and/or peripheral integration kit provides necessary tools to enable peripheral and device driver to work properly and optimally inside a VM. The tools may hook into service VM to coordinate properly amongst VMs, e.g. only make joystick available to gaming personality, not productivity personality.
   Personality behavior configurators, e.g. startup, shutdown, performance and priorities, peripheral and resource sharing: Personalities may require different optimizations to run well. One example is a CPU-intensive personality may want to have all other personalities suspended when it is the foreground personality. Another example is a personality with large amount of code may dictate certain CPU cache usage, code prefetching, and memory usage to improve its performance or startup time.
   The personality behavior configurators enable such customization per personality. Again these tools may hook into service VM to coordinate properly amongst VMs.
   Content and patch update libraries: The personality can dictate where and how it should download updates, e.g. content or patch. The update can be scheduled centrally by service VM, to ensure it is done without disrupting the user, e.g. when PC is idle or network usage is low.
   Optimization kits: Personality behavior configurators enable consumers to set general behavior and optimizations. There may be additional, very specific optimizations suitable for certain applications, e.g. special input device for a game or network QoS for video conferencing. In such cases, optimization kits can be made available to further optimize for the application.
Validation kits, validation suites, beta testing program: All personalities must meet a quality standard to provide a good customer experience. A central portal can provide guidance on testing, testing tools, and testing services to help personality creation partners to meet that goal.

### Resource Management and Performance Optimization

### Processor and Memory Management

With regard to processor and memory management:
Processor, memory, TLB, NOR flash, and cache locking: This embodiment concerns software methods for optimizing various performance aspects under virtualization.
This embodiment concerns methods to enable assignment of dedicated hardware resources to individual VMs. Switching from one VM to another currently incurs much overhead due to processor context switching, processor cache flush, and translation lookaside buffer (TLB) flush. The overhead can be significantly reduced if these hardware resources can remain dedicated to performance-intensive VMs.
Another factor in performance is startup time of VM. This startup time can be reduced significantly by using a NOR flash to store VM's boot code or to pre-fetch boot and program code from hard drive.
Silicon optimizations, e.g. processor, chipset, and memory management techniques:
This embodiment concerns hardware methods for optimizing various performance aspects under virtualization.
Fast suspend and resume: During runtime, switching amongst VMs should be instantaneous, as with switching amongst applications. This embodiment concerns methods to make starting up and shutting down VMs also fast. As this is achieved, switching out of a VM can cause the VM to shut down, thus freeing up resources to enhance system performance. With fast suspend and resume, the user sees little lag time when switching amongst VMs, yet gains the performance benefit of additional resources. One possibility for shortening startup time is to partition the VM and its applications into blocks which can be loaded piecemeal. Initially only the needed blocks get loaded from hard drive, rather than the entire VM and application code.

### I/O

With regard to I/O:
I/O bus and/or peripheral locking: This embodiment concerns methods to enable assignment of dedicated I/O resources, e.g. I/O bus, I/O device, and external peripherals, to individual VMs, for either performance or functionality reasons. For performance reasons, a graphics chip and the I/O hierarchy it resides in can be dedicated to a certain VM, e.g. a gaming personality. This particular VM's graphics operation can then be done via a native driver directly to the graphics chip, rather than via virtualized driver with significant virtualization overhead that cannot take advantage of the specific graphics chip's hardware acceleration capabilities.
For functionality reasons, a certain peripheral can be assigned to a particular VM and be made unavailable to other VMs. For example, a Bluetooth phone headset should only be used with the communications personality that has Skype and proper driver support. Another example is a hard disk or network card can be dedicated to a particular VM, for isolation reasons.
Driver reuse, e.g. wrappers for existing drivers: Linux's device driver support is far more limited than Windows's. This limitation is handicapping Linux's usefulness as the host OS for virtualization, e.g. in Xen's virtualization model, as well as Linux's applicability as a desktop OS.
This embodiment concerns methods to reuse all Windows drivers in Linux. Create mapping layers above and below Windows drivers, so that those drivers can be run as-is in a Linux OS stack.
Driver optimizations for specific personality requirements: Specific personalities may need higher I/O throughput than available via standard virtualized I/O means. One example is gaming personality needs higher I/O throughput to and from the graphics chip. The gaming personality can use a special graphics driver instead of the generic virtual graphics driver, that allows direct or prioritized access to the I/O subsystem and graphics chip.
Virtual DMA: Certain virtualization technologies implement a virtual I/O bus, to bridge I/O traffic from a guest OS to a host OS, which then accesses physical I/O devices. The virtual I/O bus can implement additional intelligence to aggregate piecemeal reads and writes into batch virtual DMA transactions, in effect reducing the number of processor cycles needed to handle virtual I/O.
Priority-based I/O on virtual buses: Some virtualization platforms, e.g. Xen, Windows hypervisor, use virtual I/O buses to pass I/O requests and responses between VMs and the host OS, which has direct access to the hardware I/O devices. A priority scheme can be overlaid on top of the virtual I/O buses to govern which requests and responses should be passed through first. This can help improve user experience in cases where some personalities are more sensitive to I/O throughput than others.
I/O virtualization techniques, e.g. drivers and silicon: There are some industry efforts in progress to improve performance and flexibility of virtualized I/O. The main effort is led by PCISIG's I/O Virtualization working group, that brings together I/O device vendors, e.g. ATI, Broadcom, etc, chipset vendors, e.g. Intel and AMD, and OS vendors, e.g. Microsoft and Linux, to define a way by which I/O is virtualized within the device itself, and a VM can access the I/O device directly without overhead of virtualizing I/O in software. This embodiment concerns areas not addressed by industry efforts that benefit consumer applications.
One possible area is to implement finer partitioning in physical, logical, and virtual mapping, e.g. VM to physical MAC and PHY, VM to physical gfx controller and frame buffer, VM to physical disk or partition. For example, with standard I/O virtualization a graphics chip may have one physical 2D graphics pipeline that is mapped to multiple logical ones. An extension has one physical 2D graphics pipeline and one 3D graphics pipeline, where 3D pipeline is dedicated to the gaming personality, whereas 2D pipeline is shared amongst all other personalities.
Physical, logical, virtual mapping techniques, e.g. VM to physical MAC and PHY, VM to physical gfx controller and frame buffer, VM to physical disk or partition.

### Architecture

Concerning the architecture:
Hypervisor and dom0 in BIOS, option ROM, or FWH.
Personalities on USB key, cell phone, iPod, in cloud: This embodiment concerns methods to make personalities portable on various devices, e.g. USB drive, cell phone, or iPod, or always available on the network, e.g. network infrastructure. The personalities fully encapsulate user data and configuration, as well as applications, so they have identical functionality and look regardless of which host PC is used.

### Usability Features

### Application Personality Coordination

This aspect of the invention refers to personalities being organized around functionality, e.g. gaming vs. productivity:

Frame and window sharing: GUI for seamless switching of personalities. MetaVNC-like, but enabled for multiple local VMs. This embodiment shows multiple personalities on-screen simultaneously, with each personality as a window to facilitate working simultaneously within multiple personalities, e.g. carry on a VoIP conversation while playing a game, or switching amongst personalities, e.g. show all personalities in miniaturized windows on the desktop so can pick the desired one with one click. MetaVNC and Apple's Expose are similar usage models.
Cut, copy, and paste, e.g. centralized clipboard: This facilitates the same cut, copy, and paste functionality amongst VMs as amongst applications. Enables usage of same short-cut keys (Ctrl-C, X, V). Enables transfer of at least text and bitmap images this way, and possibly files as well.
File access and sharing, e.g. centralized, shared, and/or distributed file system: Copy on write.
Facilitates same file copy functionality amongst VMs as amongst applications. Enables drag-and-drop of files.
One possible implementation is to use a centralized shared network folder that is accessible to all VMs, with access privileges automatically managed by service VM so that file transfer works seamlessly from user's point-of-view. Another possible implementation is for all VMs to be able to access each other's data areas.
Copy-on-write entails sharing the same data file for read purpose. A copy of the data file is made only when a write occurs. Such methodology may be used to enable multiple personalities to access the same files, with duplication necessary only when a modification is made.
Personality image optimization and compression, e.g. centralized and/or shared OS image and system files; compression and virtualization of unused space: Reduces disk space requirement of each personality by sharing core code. For example, personalities using same guest OS may contain only the additional applications and drivers beyond the common guest OS. Only one copy of the guest OS is stored, as read-only, and shared by multiple personalities.
Disk utilization by personalities can be further reduced by compression, e.g. for distribution purpose.
Favorites and preference sharing: It may be convenient for consumers to have some settings universally applied across several personalities, e.g. browser favorites. The service VM can be used to manage such common settings and configure which personalities should have them.
Streaming server to other personalities on local or remote machines, e.g. video and gfx, media files: One of the personalities can be a back end media server that stores a variety of music, movies, TV shows, etc. These media can be updated nightly from the Internet, based on consumer preferences. The consumer can access these media via a media personality with music and video players. With a wireless adapter on a television or stereo system, a consumer can also access these media through other household electronics.

### User Personality Coordination

This aspect of the invention refers to personalities being organized around user profile, e.g. teenager vs. Mom. Each may have its own set of games and communication tools:
Pre-configured family-oriented profiles and personalities: For user-oriented organization, many of the same considerations as application-oriented organization (above) apply. Some differ a bit to improve the usage model. For example, with user-oriented organization the calendar may be shared across all members of the family, as may MP3s.

### Personality and Workspace Management

With regard to this aspect of the invention:
Priority setting: Allows setting of priority of personalities, so that personalities with more stringent resource requirements, e.g. more processor or I/O bandwidth or quicker response time, can have priority access to the hardware. This helps to ensure proper user experience with the more demanding personalities, e.g. games, VoIP, etc.
Auto suspend and resume on personality switch: Allows a user to configure whether a personality gets suspended when it is switched from foreground to background. If so configured, personality automatically suspends when it is switched to background and automatically resumes when it is switched to foreground.
Fast boot and no boot: This embodiment concerns methods to make starting up and shutting down VMs also fast. If this is implemented, then switching out of a VM can actually cause the VM to shut down, thus freeing up resources to enhance system performance. With fast suspend and resume, the user sees little lag time when switching amongst VMs yet gains the performance benefit of additional resources.
Another possibility is a VM never really shuts down. Rather, it is saved off to battery-backed system memory or to hard disk.
Optimized OS images, e.g. no memory mgmt, single-tasking, no POST, etc: Strip down the guest OS to contain only the services needed for the personality's applications to work. This makes the personality smaller and faster. Personality development kit can contain tools to help personality developers generate or strip down to such minimal OS.
Switching mechanisms, e.g. docking panel, app launch bar, scroll bar, soft-keys, physical buttons: “one click personality”
Workspace grouper: This embodiment concerns grouping personalities into workspaces. Each workspace is a virtual desktop that shows a few personalities that are commonly used together, e.g. productivity and finance. Provides a way to switch amongst workspaces.
This improves productivity for those consumers who constantly use certain sets of personalities.
Avatars, e.g. external-facing identities for each container and/or one common identity for a set of containers for online gaming, communications, virtual parties and KTV, peer to peer:
Use personality traits defined by the customer profile, choice of personalities, configuration of personalities, etc. to present an avatar with those traits, for external-facing activities, e.g. online gaming and communities.

### Personality-Specific Customizations: Service VM

### Security

With regard to this aspect of the invention:
Central virus scanning and recovery; Scans for virus in all personalities.
Central spyware scanning and recovery: Scans for spyware in all personalities.
Central firewall and intrusion detection: Guards personalities against unauthorized network activity. Functionality is equivalent to a physical firewall and network security device sitting between the PC and the network.
Virtual TPM: Trusted Platform Module (TPM) ensures authenticity of code running on PC and secures sensitive information, e.g. passwords, from software and physical tampering. Service VM can perform such function for the other personalities, basing its security on sole access to the PC's TPM hardware.
Central username and password vault.
Central subscriptions and DRM manager: Personalities needing approval to access content. e.g. subscription materials, DRM-protected media, can go to service VM for centralized access control and approval.
Online update and backup of security info, e.g. preferences, passwords, virus, and spyware signature files.
Virtual VPN: When multiple PCs within the same home or across different locations are running a dedicated service VM, the service VM can facilitate setting up VPN for secure data sharing across the PCs.
Provide open source solutions.

### Backup and Restore

With regard to this aspect of the invention:
Central automated backup and recovery: Service VM automatically backs up personalities to a backup device.
Online automated backup and recovery: Service VM automatically backs up personalities to an online repository. Consumer can log into his account on system's network to restore lost or corrupt personalities.
Automated checkpoint and recovery: Service VM automatically takes snapshots of personalities, allowing the consumer to restore to a previous snapshot.

### Synchronization Among Personalities and Peripheral Devices

This aspect of the invention enables seamless synchronization of media and data amongst personalities and peripheral devices, e.g. cell phones, PDAs, iPods, camera, etc. Enables easy sharing of data amongst personalities, e.g. a common calendar shared by all user personalities within a family. This aspect of the invention enables different models of data repository, e.g. a common data repository for all personalities, separate data repositories for each personality with publish and subscribe-like functionality for sharing, etc:
Contacts
Favorites
Calendar
Notes
Media
Desktop search across personalities

### Resource Manager

With regard to this aspect of the invention:
Central download manager, e.g. BitTorrent, etc, for media, new personalities, security updates, etc:
For downloading large content and patches to customers' PCs, leverages P2P and Bit-torrent to improve download speed and reduce server infrastructure requirement. Content and updates can come piecemeal from other system customers. The updater can reside in a separate VM so not to affect the personalities.
Partitioning and repartitioning of resources among personalities, service VM tasks, and resource rentals and metering: Service VM allows assigning dedicated hardware resources to different personalities, e.g. processing power, RAM, hard drive space, etc. Unused or idle hardware resources, e.g. processor cycles or hard drive space, can even be rented out to corporate customers as distributed computing and storage resource, with service VM or a dedicated VM tracking the usage.
Peripheral drivers and sharing, e.g. printers, etc: Service VM can provide the means by which consumer configures and enables sharing.
Communication drivers, e.g. Bluetooth, infrared, 3G, UWB, WiMAX, 802.11a, etc: Service VM may manage all the communication devices, with drivers residing directly in service VM or via drivers installed in host OS. Service VM can assign devices to personalities or set limits on bandwidth available to each personality.
Virtual switch and router, e.g. intelligent, FAST; trunking: Service VM can implement a virtual switch whose virtual ports map to the personalities' network ports, as well as the PC's physical network interface. It can be used to configure which personalities have network access, which can communicate with each other, how much bandwidth is allowed for each personality, etc.
When multiple physical network interfaces are available on the PC, e.g. wireless+Ethernet+3G, the bandwidth on the multiple interfaces can be aggregated to provide a bigger pipe for the virtual switch.
Virtual switch can implement throughput-enhancing technologies such as FAST (which have guest OS-side components as well) to improve performance. An important component provides a clean, intuitive, and simple interface for consumers to configure the virtual network.
Power management: Service VM allows consumers to set energy saving policies, e.g. amount of time before PC goes to sleep, CPU performance throttling, etc, as well as wake up and sleep times for different personalities, e.g. media personality wakes up at night to download new music and movies.

### Multiple Service Personalities

With regard to this aspect of the invention:
Renting out computing resources and metering: Unused or idle hardware resources, e.g. processor cycles, hard drive space, can even be rented out to corporate customers as distributed computing and storage resource, with service VM or a dedicated VM tracking the usage.
Peer-to-peer personality: A personality can be dedicated to peer-to-peer activities, such as sharing and downloading media content. By isolating such activity to a personality, its network and processor usage can be throttled. Any malicious programs, e.g. spyware, virus, etc. do not affect other personalities.

### Personality-Specific Customizations: Media and Culture VM

This personality is primarily for downloading media content from online and playing those media content back for consumer via various interfaces. The media content can be country- or culture-specific. It may also interface to some special peripherals for interacting with certain content, e.g. microphone for karaoke content.

### Content

With regard to this aspect of the invention:
Auto download and refresh of top “100” content, which may require activation and subscription: Could be weekly “top 100” song list or top movie box office hits. Could be sample snippets of each, e.g. iTunes 30 sec snippet, movie trailers, with option to purchase.
Auto download and backup and synch of personal media files to portable devices, such as iPod, USB hard drive, etc, e.g. music, recordings, photos, videos, ring tones.
Support for popular music players, cameras, camcorders, cell phones:

Downloads media from cameras, camcorders, cell phones, etc. Lets consumers organize them and play back, similar to the role played with Apple iPhoto, iTunes, etc.

### Software and Peripherals

With regard to this aspect of the invention:
Handwriting recognition software and tablets: These input tools are becoming very popular for those needing to write Asian characters. The interface to these tools, e.g. driver for tablet device, recognition software, can be part of this personality because this personality has culture-specific aspects or it can be available to all personalities.
Microphone and Karaoke, virtual KW with webcam: This personality can interface to various peripherals for a virtual karaoke experience, such as microphone for the singing and webcam for seeing fellow singers in the virtual karaoke room.
TV tuner cards and DVR: This personality can interface to sources of content other than online, for example a TV tuner card for grabbing content from regular coax. DVR functionality can be performed in software. It can also interface with peripherals to output media content to household TV or stereo system, controlled via a remote.

### Configuration

With regard to this aspect of the invention:

The personality VM can be configured to download content specific to consumer's language, culture, country of origin, etc:
Language
Localized Settings

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. An apparatus that allows multiple computer operating systems (OS) and/or personalities to run concurrently, comprising:
an instant-on platform comprising a lightweight hypervisor that virtualizes a system network stack, wherein said instant-on platform is placed in the path of network and disk traffic between said user OS and actual system hardware; and
a user operating system environment, wherein said user OS receives network traffic from said instant-on platform, which comprises a resource management service, a caching service, a profile manager, a network stack driver which effects TCP/IP communication with the OS, and at least one appliance;
wherein the appliance is accessed using information obtained from at least one of a network, a local flash, a motherboard, a partitioned local hard disc drive, and an external memory;
wherein the resource management service accesses only the system hardware needed to run the at least one appliance while it is active.

2. The apparatus of claim 1, wherein only said system network card is virtualized and all other OS I/O functions are not virtualized, but are controlled by said user OS.

3. The apparatus of claim 1, said user operating system comprising any of:
a network configuration gadget, a media and peer-to-peer sharing gadget, a profile manager gadget, a Web site design gadget, a backup configuration gadget, and a network configuration gadget for network connections.

4. The apparatus of claim 1, said instant-on platform further comprising:
a physical disk driver interface which acts as a virtual disk driver, wherein whenever said user OS writes information to a disk, said instant-on platform converts said information to any of a backup, memory, or RAID operation, and wherein backup and memory are transparent to said user OS.

5. The apparatus of claim 1, said instant-on platform further comprising:
a physical disk driver and network interface for expanding user storage online, wherein any information said user OS writes to disk is sent via said instant-on platform to a networked virtual hard drive, wherein if online storage is not fast or secure enough for all hard drive data, then said instant-on platform discerns what information is being written and decides whether to send said information to a local drive or to an online drive.

6. The apparatus of claim 1, further comprising:
at least one virtual client that is transparent to a user for access to one or more Web-based information services whether a user computer on which said instant-on platform resides is online or offline, wherein when said user computer is online, said user accesses one or more Web-based information services from a browser, and wherein when said user computer is offline, said user accesses one or more Web-based information services locally via a Web-based information service virtual machine, wherein once a connection is reestablished with said one or more Web-based information services, said Web-based service virtual machine synchronizes with said one or more Web-based information services, updating and uploading locally modified documents.

7. The apparatus of claim 1, further comprising:
a profile manager for each of one or more users or accounts that comprises means for a user to input and save a personal profile, wherein when a user searches a public network, any desired portion of said profile can be sent to a site or portal to which said user searched.

8. The apparatus of claim 1, further comprising:
a profile manager, wherein any of the following apply;
users only input profiles that they desire;
users may grant the profile manager rights to collect their online and/or offline activities and history;
when collecting a profile, users answer a series of questions, images, or selections to determine the profile and/or interest of the user; and
users must approve passing of profile information to a site, or they may grant access for a limited period of time or for all times.

9. The apparatus of claim 8, further comprising:
a security mechanism in which information passed to one or more portals is encoded and used only via pattern matching;
wherein said profile is kept confidential and cannot be spread.

10. The apparatus of claim 8, wherein said profile is portable, wherein any of the following apply:
users can carry said profile on a USB dongle or cell phone flash;
said profile is available for online access;
users can park their personality at a Web site for access anywhere;
said profile is returned to the user after the user logs off a Web site to ensure privacy and security;
said profile and history stays with the user and not on a particular Web site or server, wherein users no longer have to re-enter their profile for every portal, users can change and erase their profiles at any time for any and all portals, and said user profile is kept confidential and is not kept by the portals.

11. The apparatus of claim 8, further comprising:
a wizard by which a user defines a profile by answering a list of questions and indicating their preferences, wherein any of the following apply;
said profiles are encrypted and saved;
said user is asked for permission to store profile information in a database online for future access;
said information is synchronized periodically;
when a user visits a Web site, said user is prompted to obtain user permission before profile information is sent to the Web site;
if said user agrees, then an encrypted file is passed to the Web site or portal;
said information is saved as a cookie so that in the future the user does not need to be asked again;
said user sees content in search results, relevance rated by users with similar profiles;
a fingerprint or pattern of the user profile is created so that the user's profile information is not disclosed;
the fingerprint or pattern is used to deliver information to the user by matching the fingerprint; and
personalized content and services are provided without knowing the user's detailed profile.

12. The apparatus of claim 1, further comprising:
means for providing power savings via virtualization by any of:
allowing system hardware to power down or to throttle back hardware reserves to what is minimally required by a currently running virtual machines, including powering down unused cores or scheduling;
virtual machines sharing cores when a computing task is not demanding;
based on a virtual machine or virtual environment running, powering off certain pieces of hardware; and
depending on a virtual machine running, using peer-evaluated performance requirements to throttle back and/or turn off processors or cores to meet performance requirements for said currently running virtual machine.

13. The apparatus of claim 1, further comprising:
a plurality of pre-installed personalities which comprise any of applications, content, services, and/or virtual machine images;
wherein virtual machine images comprise a combination of said operating system plus applications, plus content, plus services, plus data;
wherein said personalities are optionally loaded into a hard drive prior to said hard drive being assembled into a PC to enable additional OSes to be installed without impacting the existing personalities; and
wherein said personalities optionally reside in hidden partitions and are activated based on user profiles.

14. The apparatus of claim 1, in which said hypervisor and platform-specific drivers are installed in a hardware system boot ROM.

15. The apparatus of claim 1, further comprising:
means for hard drive partitioning for separation of said operating system, applications, and data.

16. A method for allowing multiple computer operating systems (OS) and/or personalities to run concurrently, comprising the steps of:
placing an instant-on platform in the path of network and disk traffic between a user OS and actual system hardware;
providing a user operating system environment, wherein said user OS receives network traffic from said instant-on platform, which comprises a resource management service, a caching service, a profile manager, a network stack driver which effects TCP/IP communication with the OS, and at least one appliance; and
providing a plurality of multi-personality windows, each window comprising a separate personality for different profiles and users;
wherein each personality optionally offers end users pre-bundled, pre-configured, and/or pre-organized content, services, and software;
wherein each personality can be one application on its own or a combination of content, services, or software;
wherein personalities optionally comprise any of packages of personalities, or super-personalities; and
wherein files and applications within each personality are separate from those of another personality and are not visible across personalities.

17. The method of claim 16, further comprising the step of:
providing a profile manager for allowing a user to select between a plurality of virtual machines, each of which expresses a different personality.

18. The method of claim 16, further comprising the step of:
aggregating I/O bandwidth when multiple devices are available to make said bandwidth available to guest OSes transparently.

19. The method of claim 16, further comprising the step of:
organizing and optimizing any of the number of icons, links, and shortcuts for each personality, and the layout of these items, for each personality's particular use case.

20. The method of claim 16, further comprising the step of:
isolating personalities by running personalities in software containers which are abstracted from an underlying platform;
wherein said personalities and containers optionally facilitate checkpointing and recovery of system state.

21. The method of claim 16, further comprising the steps of:
running only those processes and services which are needed for active personalities at any particular time; and
using suspend and resume-type operations to save entire workspaces and personality state to free up resources for other activities.

22. The method of claim 16, further comprising any of the steps of:
auto updating content, wherein media-related personalities contain content that benefit from regular updates;
auto updating personality, wherein personalities for which there are feature improvements or bug fixes after their general release are automatically updated on said user's computer while keeping all consumer data and settings intact;
P2P updating for content and personality updates by downloading large content and patches to user's computers by leveraging P2P, wherein content and updates can come piecemeal from other users, wherein an updater can reside in a separate virtual machine;
P2P updating for new and replacement personalities by downloading new or replacement personalities; and
allowing additional personalities to be recommended or proposed and downloaded for additional rebates or subsidies.

23. The method of claim 16, further comprising the step of:
application personality coordination, wherein personalities are organized around functionality, comprising any of the steps of:
frame and window sharing by showing multiple personalities on-screen simultaneously, with each personality as a window to facilitate working simultaneously within multiple personalities;
cut, copy, and paste;
file access and sharing;
facilitating same file copy functionality amongst virtual machines as amongst applications;
personality image optimization and compression;
favorites and preference sharing;
streaming server to other personalities on local or remote machines; and
user personality coordination in which personalities are organized around a user profile.

24. The method of claim 16, further comprising the step of:
performing personality and workspace management, comprising any of the steps of:
setting priority of personalities, so that personalities with more stringent resource requirements can have priority access to the hardware;
auto suspending and resuming on personality switch to allow a user to configure whether a personality gets suspended when it is switched from foreground to background and, if so configured, personality automatically suspends when it is switched to background and automatically resumes when it is switched to foreground;
fast booting and no booting to allowing fast starting up and shutting down of virtual machines, wherein switching out of a virtual machine either causes the virtual machine to shut down, thus freeing up resources to enhance system performance, or the virtual machine never shuts down, but it is saved off to battery-backed system memory or to hard disk;
optimizing OS images, wherein a guest OS is stripped down to contain only services needed for a personality's applications to work;
providing one or more switching mechanisms, comprising any of a docking panel, application launch bar, scroll bar, soft-keys, and physical buttons;
providing a workspace grouper for grouping personalities into workspaces, where each workspace is a virtual desktop that shows a few personalities that are commonly used together, and where a user is provided with means to switch amongst workspaces; and
providing avatars, comprising external-facing identities for each container and/or one common identity for a set of containers for user personality traits defined by a customer profile, choice of personalities, or configuration of personalities.

25. The method of claim 16, further comprising the step of:
providing one or more personality-specific customizations comprising any of:
security customizations comprising any of central virus scanning and recovery, central spyware scanning and recovery, central firewall and intrusion detection, virtual Trusted Platform Module (TPM), central username and password vault, central subscriptions and DRM manager, online update and backup of security information, virtual VPN, and open source solutions;
backup and restore customizations comprising any of central automated backup and recovery, online automated backup and recovery, and automated checkpoint and recovery;
synchronization among personalities and peripheral devices enabling seamless synchronization of media and data amongst personalities and peripheral devices, easy sharing of data amongst personalities, and different models of data repository;
resource manager customizations comprising any of a central download manager, for media, new personalities, security updates, partitioning and repartitioning of resources among personalities, service virtual machine tasks, and resource rentals and metering, assigning dedicated hardware resources to different personalities, and peripheral drivers and sharing;
multiple service personalities customizations comprising any of renting out computing resources and metering and dedication to peer-to-peer activities; and
personality-specific customizations comprising any of downloading media content from online and playing those media content back for consumer via various interfaces.
